(19) United States
(12) Patent Application Publication
(10) Pub. No.: US 2008/0279349 A1
(43) Pub. Date: Nov. 13, 2008

(54) MEDIA WITH EMBEDDED NETWORK SERVICES

(76) Inventors: Christopher Jaffe, San Mateo, CA (US); Ronald Martinez, San Francisco, CA (US); Erik Almenberg, Chicago, IL (US)

Correspondence Address: BRINKS HOFER GILSON & LIONE / YAHOO! OVERTURE, P.O. BOX 10395, CHICAGO, IL, 60610, US

(21) Appl. No.: 11/745,276

(22) Filed: May 7, 2007

(51) Int. Cl. H04M 11/00

(52) U.S. Cl. 379/88.14

(57) ABSTRACT

A system and method for providing network services to a user of a computer capable of displaying Internet based media, such as sequential media, played by a media player in a display. The method includes the steps of providing a media object, wherein the media object contains sequential media and network services information encapsulated within the media object. Encapsulating the sequential media and network services information within the media object prevents rogue users from simply stripping away the sequential media from the network services information.

### BACKGROUND OF THE INVENTION

1. Field of the Invention

The invention relates to network services and more specifically to network services integrated within Internet based media.

2. Description of the Known Technology

Networked electronic devices, such as personal computers, mobile phones, personal digital assistants, game consoles, interactive television or automative telematic devices, increasingly contain sequential media, such as video and audio clips. In the past, advertising necessary to provide economic return to support the development of sequential media have been restricted to graphical advertisement such as banner advertisements or text based advertisements, either of which is placed somewhere in a web page containing the sequential media.

However, in order to gain advertisement revenue, the sponsor of the sequential media must find a way to keep users or drive users to their web page. One drawback to this form of advertising is that the sequential media is often detachable from the web page from where it originates and can appear in any of the number of different contexts. For example, sequential media, such as a video found on Yahoo! can be placed on web pages that are not hosted or searched by Yahoo!. To be more specific, a video clip originally found on Yahoo! may be embedded using HTML code into a third party's personal web page. Therefore, given the mobility and variety of context sequential media appears in, advertisement simply appearing in the page where the media first originated does not provide the necessary revenue and customer service opportunities needed to support the sequential media's hosting and distribution costs.

Therefore, there is a need for an improved method for driving traffic to web pages using sequential media.

### BRIEF SUMMARY OF THE INVENTION

In overcoming the drawbacks of the prior art, a system and method for providing network services to a user of a computer capable of displaying Internet based media, such as sequential media, played by a media player in a display is disclosed. The method includes the steps of providing a media object, wherein the media object contains sequential media and network services information encapsulated within the media object. As stated in the background section, one of the drawbacks of prior art solutions is that rogue users can simply strip away the sequential media from any advertising information. Encapsulating the sequential media and network services information within the media object prevents rogue users from simply stripping away the sequential media from the network services information.

Other steps of the method include displaying sequential media of the media object in the display utilized by the media player and displaying a network services platform in at least a portion of the display utilized by the media player when prompted by a first user action, the network services platform contained within the networking services information of the media object

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system for providing advertising and network services to a user viewing Internet based media;

FIG. 2 is a screen capture of a media player displaying a pre-roll advertisement;

FIG. 3 is a screen capture of the media player of FIG. 2 displaying media and a persistent banner advertisement;

FIG. 4, is a screen capture of the media player of FIG. 2 displaying a rich media advertisement;

FIG. 5, is a screen capture of the media player of FIG. 2 displaying tabs for initiating a network services platform; and

FIG. 6, is a screen capture of the media player of FIG. 2 displaying the network services platform.

### DETAILED DESCRIPTION OF THE INVENTION

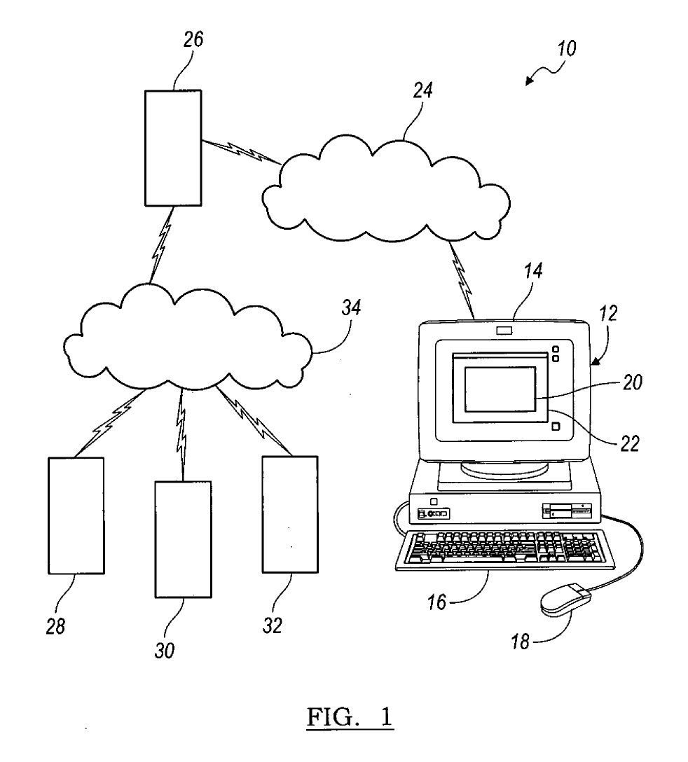

Referring to FIG. 1, a system 10 for providing advertising and network services to a user viewing Internet based media is shown. Preferably, the Internet media is sequential media, however, the Internet based media may be any type of Internet based media, such as still images. Sequential media includes visual, audible and other information presented in a sequence of discrete portions or a continuous stream of information, or a combination of these. The sequential media may be encoded as digital data or analog signals for processing, playback, storage or other use using appropriate hardware or software tools.

The system 10 includes a general purpose computer 12 having a display 14 and input devices such as a keyboard 16 and a mouse 18. The general purpose computer 12 is capable of displaying via the display 14 sequential media played by a media player 20. The media player 20 may be located within a window 22 of an Internet browser. However, it should be understood that the media player 20 may be located anywhere such that the display 14 can display the media player 20 to the user of the general purpose computer 12. The general purpose computer 12 is connected to a network 24 that is preferably a distributed network such as the Internet.

In order for the media player 20 to display sequential media, a media object containing the sequential media must be provided to the general purpose computer 12. A central server 26 accomplishes this task by transmitting a media object to the general purpose computer 12 via the network 24. As will be better described later, the media object contains not only the sequential media but also contains at least one of (1) advertising information and (2) network services information. The advertising and/or network services information is encapsulated within the media object, thereby preventing rogue users from stripping out the advertising and/or network services information from the sequential media contained within the media object. By so doing, parties providing the sequential media can justify the expense in creating the sequential media because advertisement or network services will be contained within the media object encouraging users to buy products or use the network services offered by the provider.

Before the media object is sent to the general purpose computer 12, the central server 26 must first construct the media object to include the sequential media as well as any advertising information and/or network services information. The central server 26 accomplishes this task by requesting the sequential media, advertising information and network services information from a sequential media server 28, an advertisement server 30 and a network services server 32, respectfully, via a network 34. Similar to the network 24, the network 34 is generally a distributed network such as the Internet. However, it should be understood that the network 26 may be a local or wide area network.

When constructing the media object, the server 26 will request the appropriate sequential media from the sequential media server 28. At around the same time, the central server 26 also requests the appropriate advertising information and/or network services information from the advertising server 30 and the network information server 32, respectively. It should be understood that the central server 26 may select the appropriate advertising information and/or network integration services information based upon a variety of algorithms. For example, as will be described later, the central server 26 may construct the profile of the user of the general purpose computer 12 such that the requested advertising information or network services information is more likely to be of interest to the user of the general purpose computer 12. This may be accomplished by generating a central profile of the user of the general purpose computer 12. The central profile may be constructed by tracking the user's interaction with the general purpose computer 12 or by collecting information stored within the general purpose computer 12.

After the sequential media as well as the advertising information and/or networking services information is provided to the central server 26, the central server 26 will then create the media object encapsulating both the sequential media and the advertising information and/or network services information within the media object.

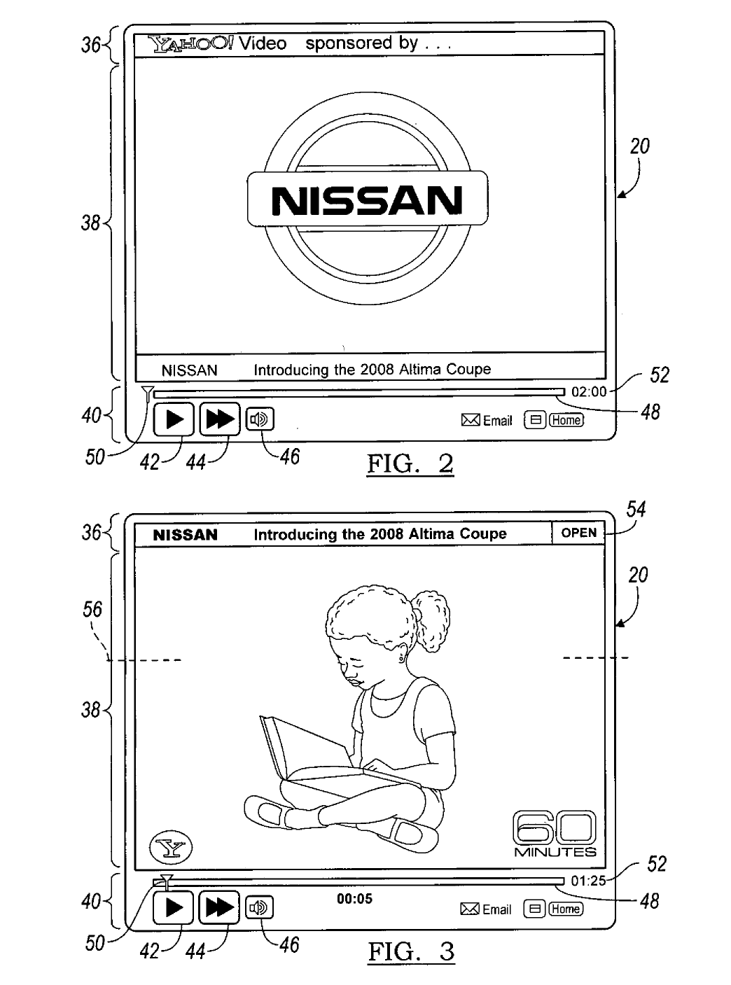

Referring to FIGS. 2 and 3, the portion of the display 14 being used by the media player 20 can be divided into three areas: a persistent banner 36, a sequential media area 38 and a control area 40. The persistent banner 36 in this exemplary embodiment is generally located at or near the top of the viewing area of the sequential media player 20. As best shown in FIG. 31 the persistent banner 36 contains advertising originating from the advertising information provided by the advertising server 30.

The sequential media area 38 is a portion of the media player 20 used to display the sequential media. As stated before, although this embodiment shows the media player 20 displaying sequential media, any type of Internet based media may be displayed. Located below the sequential media area 38 in this embodiment is the control area 40. The control area 40 includes a variety of controls for controlling the sequential media in the sequential media display area 38. The controls include a play button 42 for playing the sequential media, a fast forward button 44 for fast forwarding the sequential media, and a sound button 46 for adjusting the sound (if any) of the sequential media.

Additionally, the control area may include a progress bar 48 having a progress indicator 50 for graphically indicating the amount of play time left for the sequential media. A timer 52 can be displayed indicating the amount of time the sequential media has played or amount of playing time remaining. Of course, additional controls and indicators may be implemented within the control area 40 to provide the user additional ways to interact with the sequential media.

When the general purpose computer 12 receives the media object from the central server 26, the media player 20 will first display a pre-roll advertisement as shown in FIG. 2. Like the persistent banner 36, the pre-roll advertisement originated from the advertising information provided by the advertising server 30. The pre-roll advertisement is typically a short advertisement lasting less than about five seconds. The pre-roll advertisement may be configured such that if the user clicks on the pre-roll advertisement, a website relating to the subject matter of the pre-roll advertisement may be launched. For example, the user may use a mouse or other pointing device attached to a computer displaying the media object to select or click on the pre-roll advertisement. In response, a web browser program is launched by the computer and directed to a website designated by the pre-roll advertisement.

The purpose of the pre-roll advertisement is to notify the user of the advertising sponsor without annoying the user such that the user decides not to view the sequential media. Furthermore, in order to further reduce the user's anxiety in waiting for the pre-roll advertisement to finish, a timer may be displayed to inform the user of the remaining duration of the pre-roll advertisement.

Referring now to FIG. 3, once the pre-roll advertisement has finished playing, the sequential media is displayed in the sequential media area 38. The persistent banner advertisement 36 is located above the sequential media area 38 and advertises products and services offer by the advertiser first displayed in the pre-roll advertisement. However, it should be understood that the persistent banner advertisement may be from a different advertiser than that of the pre-roll advertisement.

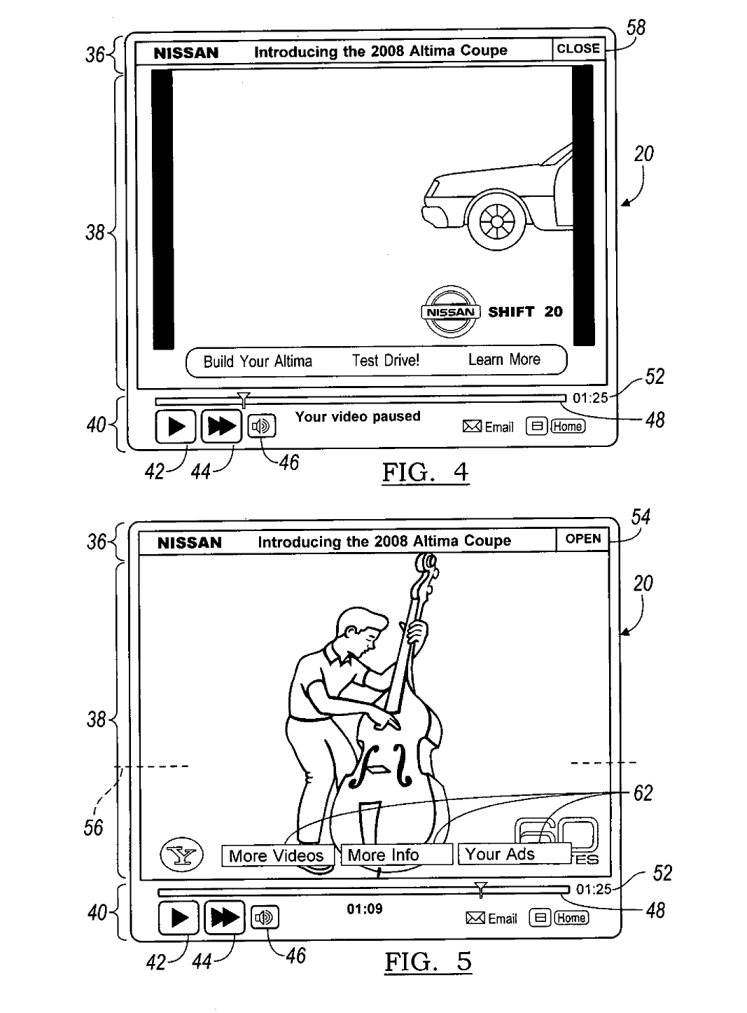

As the sequential media plays within the sequential area 38, the user 12 can then open a rich media advertisement shown in FIG. 4. Like the persistent banner 36 and pre-roll advertisement, rich media advertisement originated from the advertising information provided by the advertising server 30. The rich media advertisement of FIG. 4 can be opened in a variety of ways. The rich media advertisement may be opened by clicking the open button 54 shown in FIG. 3. Alternatively, the rich media advertisement may be opened by moving a cursor with the mouse 18 within an area located within the sequential media area 38. For example, this area may be the top one third of the sequential media area 38 as designated by line 56. An indicator (not shown) may be utilized by the media player 20 to encourage the user to open the rich media advertisement.

The rich media advertisement is displayed in at least a portion of the sequential media display area 38. The rich media advertisement may be a video, an interactive computer game, a configurator for building, pricing and buying goods and/or services, a static advertisement, a micro web site capable of launching other web sites, an interactive map, an Internet telephony connection, an instant messaging connection or any combination of the above. Of course, the rich media advertisement can be any one of a number of electronic advertising systems capable of being displayed on the display 14 of the general purpose computer 12.

When the rich media advertisement is displayed, the sequential media which may have been previously playing is paused while the rich media advertisement is displayed. The rich media advertisement can be removed from the sequential media display area 38 by selecting a close button 58 located within the persistent banner advertisement 36 or by simply pressing the play button 42. An indicator (not shown) may be utilized by the media player 20 to encourage the user to close the rich media advertisement.

Another way for initiating the display of the rich media advertisement is to allow the media player 20 to finish playing the sequential media. When the sequential media is finished playing by the media player 20, the rich media advertisement can then be displayed within the sequential media area 38.

As the user interacts with the rich media advertisement, information may be collected regarding the user's interactions. This can then be forwarded to the advertisement server 30. The information may then be used to create a profile indicating advertisements likely to pique the interest of the user. Once the profile has been created, the advertisement server 30 can then customize the rich media advertisement with the intention of providing a rich media advertisement likely to be of interest to the user.

The user's interaction with the rich media advertisement can include several factors. These factors may include time spent interacting with the rich media advertisement, behavior of the user when interacting with the rich media advertisement, performance metrics of the rich media advertisement, execution speed of the rich media advertisement, time and date when the user interacted with the rich media advertisement, the Internet Protocol address of the user, the user's system, platform, and web browser configuration information and the user's media identifier information.

Additionally, user information may be sent to a remote location such as the central server 26 (FIG. 1) such that the central server 26 can generate a profile based on the user information. After a profile is generated, the central server 26 can modify the advertising information contained within the media object based upon the profile. The user information collected by the central server may contain information regarding the user's interaction with the rich media advertisement. However, the user information may also contain information relating to a web page in which the sequential media is displayed.

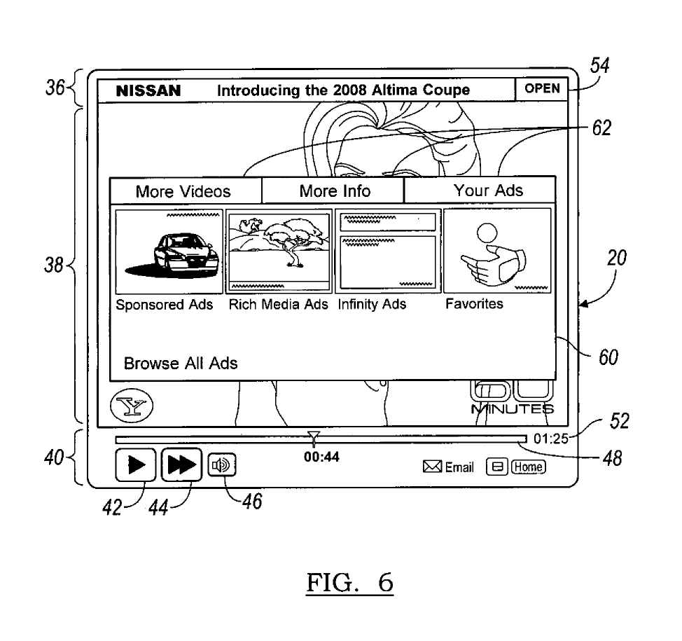

Referring to FIGS. 5 and 6, network services information contained within the media object can also be displayed within the media player 20 as well. The network services information provides additional information to the user of the general purpose computer 12. It should be understood that the network services information displayed within the media player 20 can be displayed in concert with the advertising information discussed in FIGS. 2-4 or by itself.

By providing additional information to the user, the user will be encouraged to either view additional advertisements or be encouraged to visit websites of those parties sponsoring the sequential media. Like the advertising information, the network services information is not limited to use only with sequential media, but may be used with other types of media such as still pictures.

Referring to FIG. 6, when initiated by the user, a network services platform 60 will appear in at least a portion of the sequential media area 38. The network services platform 60 will display a variety of different network services available to the user, such as video, images, text, audio, data streams, and e-commerce functionality. For example, the network services platform 60 may display a list of previously viewed or related media being of a similar subject matter that to the media first displayed in the sequential media area 38. The network services platform 36 may also be a search result from an Internet search engine based upon search terms related to a sequential media displayed in the sequential media area 38. Additionally, the network services platform may also include a facility for sharing data with others via instant messaging, email, telephone or Internet telephony.

The network services platform 60 can be initiated to be displayed within the sequential media area 38 when the sequential media has finished playing or by moving the cursor with the mouse 18 below a line 56 of FIG. 5 of a media player 20. Additionally, as best shown in FIG. 5, the sequential media display area 38 may include a series of tabs 62 located near the bottom of the sequential media area 38. By selecting one of the tabs 62, the network services platform 60 will be displayed within the sequential media area 38. Other techniques for displaying the network services platform 60 may be implemented as well.

When the network services platform 60 is displayed, the sequential media which may continue playing or may be paused while the network services platform 60 is displayed. The network services platform 60 can be removed from the sequential media display area 38 after a fixed duration without any interaction from the user.

Generally, information provided within the network services platform 60 will relate to the tab 62 selected by the user. For example, if the tab 62 displaying more media, thumbnails of the additional media will be displayed within the network services platform 60. Alternatively, if the tab 62 relates to providing the user more information relating to the subject of the media displayed in the sequential media area 38, the network services platform 60 will display more information such a search provided by an Internet search engine.

Moreover, as the user interacts with the network services platform 60 information regarding the user's interaction with the network services platform 60 can be sent back to the central server 26 such that a profile can be generated relating to the user. By so doing, the central server 26 or a third party can customize the network services provided to the user based upon the profile generated based upon the user's interaction with the network services platform 60.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for providing network services to a user of a computer capable of displaying media played by a media player in a display, the method comprising the steps of:
providing a media object, wherein the media object contains media and networking services information;
displaying sequential media of the media object in the display utilized by the media player; and
displaying a network services platform in at least a portion of the display utilized by the media player when prompted by a first user action, the network services platform contained within the networking services information of the media object.

2. The method of claim 1, wherein the media is sequential media.

3. The method of claim 1, wherein the network services platform a list of previously viewed media.

4. The method of claim 1, wherein the network services platform is a list of related media, the related media being of a similar subject matter to the media.

5. The method of claim 1, wherein the network services platform is a search result from an internet search engine, the search result based upon search terms related to the media.

6. The method of claim 1, further comprising the step of displaying at least one tab in a portion of the display.

7. The method of claim 6, wherein the first action is selecting the at least one tab with a cursor.

8. The method of claim 1, wherein the first user action is placing a cursor over a portion of the display utilized by the media player.

9. The method of claim 1, further comprising the steps of:
sending user information to a central server;
generating a central profile based on the user information; and
modifying the networking services information contained within the media object based upon the central profile.

10. The method of claim 1, further comprising the step of displaying the network services platform in the display when the media has finished playing.

11. The method of claim 1, further comprising the step of removing the network services platform from the display utilized by the media player after a fixed duration without any interaction from the user.

12. The method of claim 1, further comprising the step of removing the network services platform from the display utilized by the media player when prompted by a second user action.

13. The method of claim 12, wherein the second user action is selecting a play button of the media player.

14. The method of claim 12, further comprising the step of displaying media in a second part of the display utilized by the media player when prompted by the second user action.

15. The method of claim 1, wherein the networking services information is customizable by a third party for displaying a customized network services platform.

16. The method of claim 1, wherein the network services platform further comprises a user input form for receiving search terms, whereby search terms entered into the user input form are submitted to an Internet search engine.

17. The method of claim 1, wherein the network services platform further comprises at least one of a facility for sharing data with others via instant messaging, e-mail, telephone and internet telephony.

18. The method of claim 1, wherein the network services platform further comprises at least one of video, images, text, audio, data streams, and e-commerce functionality.

19. The method of claim 1, further comprising the step of sending user information related to at least one of the user's interaction with the network services platform to a central server or a third party, the user information being at least one of performance of the user's computer and technical configurations of the user's computer.

20. A system for providing network services to a user's computer capable of displaying media played by a media player in a display, the system comprising:
a central server in communication with a media server and a network services server;
the central server being configured to receive network services information from the network services server, wherein the network services information contains data for displaying a network services platform in at least a portion of the display utilized by the media player;
the central server being configured to receive media information from the media server wherein the media information contains data for displaying media in a second part of the display utilized by the media player;
the central server being configured to construct a media object encapsulating the media information and the network services information, the media object capable of being displayed by the media player in the display of the user's computer; and
the central server being configured to transmit the media object to the user's computer.

21. The system of claim 20, wherein the media is sequential media.

22. The system of claim 20, wherein the network services platform a list of previously viewed media.

23. The system of claim 20, wherein the network services platform is a list of related media, the related media being of a similar subject matter to the media.

24. The system of claim 20, wherein the network services platform is a search result from an internet search engine, the search result based upon search terms related to the media.

25. The system of claim 20, wherein the network services information contains data for displaying at least one tab in a portion of the display.

26. The system of claim 20, wherein the central server is configured to receive user information, generate a central profile based on the user information and modify the network services information contained within the media object based upon the central profile.

27. The system of claim 20, wherein the networking services information is customizable by a third party for displaying a customized network services platform.

28. The system of claim 20, wherein the network services platform further comprises a user input form for receiving search terms, whereby search terms entered into the user input form are submitted to an Internet search engine.

29. The method of claim 20, wherein the network services platform further comprises at least one of a facility for sharing data with others via instant messaging, e-mail, telephone and internet telephony.

30. The method of claim 20, wherein the network services platform further comprises at least one of video, images, text, audio, data streams, and e-commerce functionality.
